(19) United States
(12) Patent Application Publication
(10) Pub. No.: US 2026/0341004 A1
(43) Pub. Date: Oct. 29, 2026

(54) REFERENCE-FREE EVALUATION OF COLOR CONSISTENCY IN TEXT-TO-IMAGE GENERATION MODELS

(71) Applicant: SAP SE, Walldorf (DE)

(72) Inventors: Junxiang Jia, Singapore (SG); Laddie Ji Cheng Tan, Singapore (SG); Louise Tan, Singapore (SG); Zhen Shu, Singapore (SG)

(73) Assignee: SAP SE, Walldorf (DE)

(21) Appl. No.: 19/188,505

(22) Filed: Apr. 24, 2025

(51) Int. Cl. G06V 10/776; G06T 11/00; G06V 10/56; G06V 10/74

(52) U.S. Cl. CPC G06V 10/776; G06T 11/00; G06V 10/56; G06V 10/761

(57) ABSTRACT

Techniques are disclosed for evaluating and improving color consistency across images generated by a text-to-image model in response to a common prompt. A plurality of images are generated using a fixed configuration, and color distribution features are extracted from each image. Similarity measures are computed between images, and an alignment score is calculated to reflect consistency in color composition across the set. If the alignment score falls below a threshold, one or more components of the configuration—such as the prompt, preprocessing logic, model selection, or post-processing—may be iteratively adjusted to improve consistency. In some implementations, spatial color consistency is also assessed using region-based analysis. Once an optimized configuration is identified, it can be used in a subsequent inference phase to generate final outputs with improved visual coherence. The approach is reference-free and applicable even when no explicit color specification or reference image is provided.

### FIELD

This disclosure relates generally to image generation and prompt-based content synthesis. More specifically, it pertains to the evaluation, scoring, and optimization of color consistency across images generated by text-to-image models, including but not limited to reference-agnostic color alignment metrics, configuration refinement pipelines, and automated prompt adjustment using language and vision-language models.

### BACKGROUND

Text-to-image generation models are increasingly used to produce visual content based on natural language prompts. These models are typically nondeterministic, such that repeated generations using the same prompt and configuration can yield different visual outputs. While this variability can be useful for exploration or creativity, it also introduces challenges in contexts where visual consistency is important.

Color usage is one aspect of visual presentation that can vary across generations. Depending on how the model interprets a prompt, it may produce different dominant color schemes in otherwise semantically similar images. This variation may be undesirable in a range of settings, including—but not limited to—product visualization, training datasets for machine learning, automated UI generation, and presentation materials. In these contexts, consistency across multiple generated images can affect usability, quality perception, and downstream processing.

One way to address this problem is to compare each image to a reference color scheme or palette. However, doing so requires the user or a computing process to specify the desired colors or provide a reference image, and assumes that the reference is well-defined and representative. In many cases, no reference is available, or the desired visual outcome is underspecified. Even where a reference is provided, checking whether a single generated image is consistent with it does not capture whether future generations using the same prompt will produce similar results. That is, single-image evaluation provides no insight into the stability or repeatability of the model's color behavior for that prompt. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques are disclosed for evaluating and improving color consistency across images generated by a text-to-image model in response to a common prompt. A plurality of images are generated using a fixed configuration, and color distribution features are extracted from each image. Similarity measures are computed between images, and an alignment score is calculated to reflect consistency in color composition across the set. If the alignment score falls below a threshold, one or more components of the configuration—such as the prompt, preprocessing logic, model selection, or post-processing—may be iteratively adjusted to improve consistency. In some implementations, spatial color consistency is also assessed using region-based analysis. Once an optimized configuration is identified, it can be used in a subsequent inference phase to generate final outputs with improved visual coherence. The approach is reference-free and applicable even when no explicit color specification or reference image is provided.

In one aspect, the present disclosure provides a process for evaluating color consistency in image generation and using an alignment score to guide configuration refinement.

A plurality of images is generated by a text-to-image model operating under a fixed configuration in response to a common prompt. For respective images of the plurality of images, a set of color distribution features is extracted based on pixel-level color content of the respective image. One or more similarity measures are computed across the plurality of images based on the extracted color distribution features.

An alignment score is calculated that reflects the consistency of color composition across the plurality of images based on the computed similarity measures. The alignment score is used to influence configuration selection, prompt refinement, or image generation workflow behavior, in order to provide an improved alignment score.

The present disclosure also includes computing systems and tangible, non-transitory computer readable storage media configured to carry out, or including instructions for carrying out, an above-described method. As described herein, a variety of other features and advantages can be incorporated into the technologies as desired.

### BRIEF DESCRIPTION OF THE DRAWINGS

FIG. 1 are flowcharts illustrating an evaluation process used to optimize an image generation configuration and an inference phase that uses the optimize configuration.

FIG. 2 is a flowchart illustrating example prompt generation.

FIG. 3 depicts an example process for determining a reference agnostic color alignment score.

FIG. 4 is a diagram illustrating computing a spatially aware reference agnostic color alignment score.

FIG. 5 is a flowchart of a process for evaluating color consistency in image generation and using an alignment score to guide configuration refinement.

FIG. 6 is a diagram of an example computing system in which the described embodiments can be implemented.

FIG. 7 is an example cloud computing environment that can be used in conjunction with the technologies described herein.

### DETAILED DESCRIPTION

### Example 1)—Overview of Reference Agnostic Color Alignment Determination

Continuing from the Background, the problem of variability in color presentation across generations is particularly acute when no explicit color is specified in the prompt and no reference image is available for comparison. A single image generated in response to a prompt may appear visually consistent with an intended style or aesthetic, but there is no guarantee that future generations using the same prompt will produce images with similar visual characteristics. In other words, checking whether a single image is consistent with an implicit or explicit color scheme provides no information about whether the image generation process itself is consistent. A prompt that produces a satisfactory image once may produce inconsistent or jarring results when used repeatedly, especially in batch settings or applications that rely on repeated generation, such as content libraries, automated UI construction, or training data synthesis.

This issue arises regardless of whether the prompt explicitly references color. Where no color is specified, it is often desirable for generated images to exhibit a coherent visual tone or style that aligns with user expectations, even if those expectations are not formalized in advance. Where a color is specified, conventional evaluation approaches compare each generated image against the specified color or reference palette. However, this type of per-image scoring can miss the larger issue of generation stability. A prompt may produce individual images that each appear consistent with the specified color, but that differ significantly from each other in how that color is interpreted or rendered. For example, a prompt requesting a “blue-themed background” may yield one image with a strong dominant blue tone, another with a subtle blue accent, and a third with blue distributed as a minor overlay. Each image might pass a reference-based check in isolation, but still be perceived as inconsistent when viewed together. This type of variation can undermine workflows that depend on visual harmony across a set of assets.

The approach described in the present application addresses this problem by evaluating the color consistency across multiple images generated using the same prompt and generation configuration. Rather than relying on a fixed reference image or color palette, the system evaluates whether the images in the generated set are internally consistent with one another in terms of color content. This reference-agnostic strategy is particularly useful in cases where prompts are underspecified or intentionally open-ended, where no reference palette exists, or where the goal is to assess the stability of the model's interpretation of a prompt over time. It also complements reference-based approaches by providing an independent axis of evaluation, revealing whether the model is applying the reference in a repeatable way.

At a high level, the technique begins by generating a plurality of images using the same text-to-image prompt and generation configuration. Each image is converted into a set of color vectors, typically in RGB space, by flattening its pixel data into three-dimensional vectors. The color vectors for each image are then clustered, for example using K-Means clustering, to identify dominant colors and their relative prevalence within the image. These clusters are characterized by their centroid positions in color space and the number of pixels associated with each centroid.

To assess color alignment between images, the system computes similarity scores between the clusters of different images, typically using cosine similarity or another vector-based metric. The similarity scores are weighted according to the number of pixels in each cluster, so that dominant colors contribute more heavily to the alignment score. The final color alignment score is based on an aggregation of the pairwise scores across the set of images. This score reflects how consistent the model's interpretation of the prompt is with respect to color characteristics, without reference to a predefined target.

While a person might be able to judge whether images look visually similar, the disclosed techniques perform a level of quantitative image analysis that is impractical to carry out manually. Each image typically consists of hundreds of thousands or millions of pixels, each with an associated RGB vector. Determining whether a set of such images exhibits consistent color alignment requires clustering these vectors, computing the centroids of those clusters, determining the size of each cluster, and computing pairwise similarity scores across all cluster combinations between image pairs. Doing so by hand or using only general-purpose tools would not be feasible at scale or with the level of precision provided here, such as when results are to be provided in real time, such as determining color alignment in less than 30 seconds.

Moreover, disclosed techniques can detect cases where images are inconsistent in subtle or non-obvious ways, such as when two images share the same color proportions but differ substantially in how those colors are spatially distributed-a distinction that may escape human reviewers. By converting visual data into structured representations and applying algorithmic comparison methods, the technique enables a computer system to perform a consistency analysis that is more scalable, repeatable, and sensitive than human visual inspection.

If the alignment score falls below a predefined threshold, the prompt or model configuration may be revised. Revisions may include modifying the prompt template, altering preprocessing or post-processing layers, or substituting or retraining the underlying image generation model. These adjustments can be made manually or automatically. In one embodiment, a vision-language model receives the prompt and the results of the color alignment analysis and returns a modified prompt that is expected to produce more color-consistent results. This process can be iterated until the alignment score exceeds the threshold or a maximum number of attempts is reached. The resulting prompt and configuration can then be used as an optimized setup for inference.

Prompt templates may include both system-defined and user-supplied components. A base template may define the structure of the prompt, such as the task to be performed (e.g., “Generate a cover image for a course titled . . . ”) and constraints (e.g., “Do not include people in the image”). The user input is inserted into the template along with any available metadata, such as course name or category, and optionally, user-specified color terms. Whether or not color information is included, the system can apply the alignment metric during evaluation and optimization phases to assess the stability of the output.

The techniques can also account for the spatial distribution of color within an image. Two images may contain the same dominant colors in the same proportions, but differ significantly in how those colors are arranged spatially. To address this, the image may be divided into a grid, and color alignment can be computed within each grid cell. Alignment scores can then be aggregated across corresponding cells in the grid to yield a more spatially sensitive assessment of color consistency. This refinement allows the system to penalize cases where a color is concentrated in a small area of one image but spread evenly in another, even if their global color distributions are similar.

This combination of reference-agnostic scoring, optional prompt and model adjustment, spatial sensitivity, and structured analysis of color data provides a robust framework for evaluating and optimizing consistency in image generation without requiring human review or predefined targets. It supports applications ranging from enterprise content generation to automated asset production for training pipelines, where visual coherence is important but difficult to specify in advance. The approach leverages structured data, mathematical comparison, and machine-executed logic to perform an analysis that is not practically or reliably achievable using manual processes or conventional unstructured evaluation methods.

### Example 2)—Example E Valuation and Inference Phases Using Reference Agnostic Color Alignment Scores

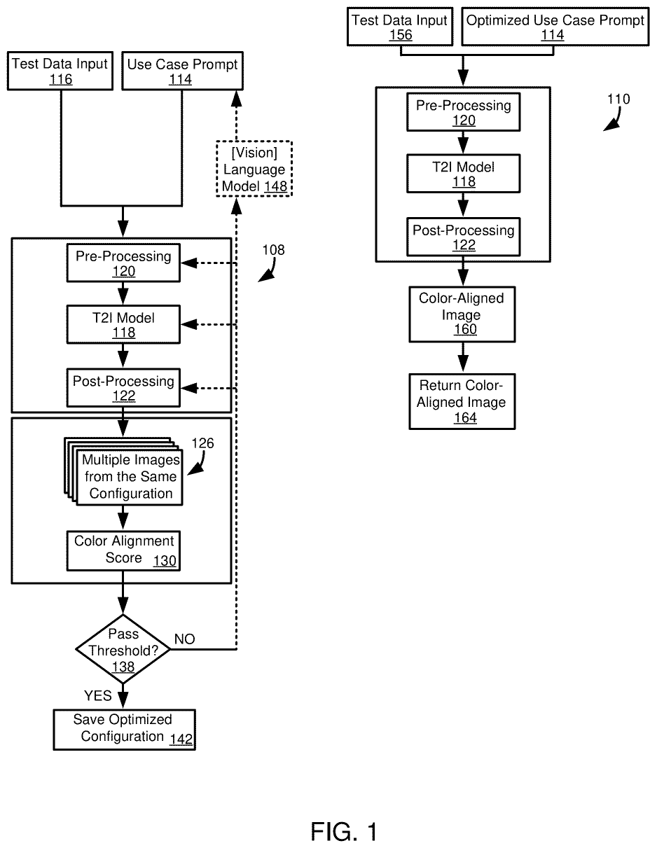

With reference to FIG. 1, in one embodiment, disclosed techniques includes two primary phases: an evaluation process 108 and an inference phase 110. During the evaluation process 108, multiple images are generated in response to the same input prompt and model configuration, and an iterative evaluation is performed regarding the degree of color consistency among the resulting images. This evaluation process may involve multiple iterations, with prompt or configuration refinements applied between cycles if the consistency score is below a defined threshold.

The evaluation process 108 may be used during system configuration, prompt engineering, model selection, or other tuning steps in which a particular combination of inputs is tested to determine whether it produces reliable and repeatable outputs. The inference phase 110, by contrast, applies an optimized configuration derived from a successful evaluation process 108 to generate a single image or a production-level batch of images for deployment or consumption.

In enterprise deployments, such as SuccessFactors Image Generation for Learning, this evaluation framework may be applied as part of a quality control and optimization pipeline for production-scale generative image outputs. In this scenario, reference-agnostic scoring provides a way to help provide visual consistency across multiple regeneration attempts made by end users issuing similar prompts. When no reference palette is available, intra-prompt consistency becomes the primary tool for maintaining aesthetic alignment and branding fidelity.

The evaluation process 108 begins with a common configuration state that includes a prompt (or prompt template) 114, test input data 116, an image generation model 118, and any applicable preprocessing 120 or post-processing 122 logic. This state is held constant while the system submits the same prompt multiple times, serially or in parallel, to the image generation model 118, producing a corresponding set of generated images 126.

Because modern text-to-image generation models are nondeterministic—often due to latent space sampling or other sources of internal randomness—each submission may yield a different output image. The purpose of each iteration of the evaluation process 108 is to assess whether those outputs are consistent in their color characteristics, thereby providing insight into whether the prompt and configuration are stable and well-behaved under repeated application. The process treats the combination of prompt template, image generation model, preprocessing logic, and post-processing settings as a single configuration state, which is held constant throughout a given iteration of the evaluation loop.

The consistency assessment is reference-agnostic. That is, determining a color alignment score 130 from the set of generated images 126 does not compare the images against a predefined palette or reference image. Instead, it compares the generated images 126 against each other, using quantitative color clustering and similarity metrics to determine whether the outputs reflect a coherent color interpretation of the prompt. In this way, the system can identify whether a particular configuration tends to produce outputs that are stable in color composition, even when no explicit color guidance is given.

In some implementations, the test data input 116 corresponds to user or process supplied information that is inserted into a prompt template, such as the user case prompt 114. A template itself can have multiple levels, being itself assembled from lower-level components. For example, a user may supply a course name and an optional field for additional visual requirements as test data input 116. These values are inserted into the user case prompt 114, which is then inserted into a final prompt template (not shown). This multi-stage construction allows for greater flexibility and more granular prompt tuning during evaluation. While prompt templates can be used, disclosed techniques can be used with static prompts or prompts having static elements.

In a typical implementation, a prompt, such as the use case prompt 114 or a higher level prompt is constructed by combining one or more user- or process-supplied values in the test input data 116 with a standard prompt template 114. The user or calling process may provide values for fields such as a course title, topic category, product type, or other contextual input. The template 114 defines the general structure of the prompt and may include fixed language (e.g., “generate a visually compelling cover image”) as well as placeholder fields to be populated with runtime inputs. For example, the template 114 may include a variable for the course title or a color list if branding information is available. Where color is not specified, the prompt simply omits that field.

A constructed prompt 114 that does not include color might read as follows:
“Generate a visually compelling cover image for a digital learning course titled ‘Introduction to Project Management Essentials.’ The image should reflect the course topic. Do not include any text or human figures.”

This prompt 114, combined with the test input data 116, is submitted multiple times to the text-to-image generation model 118 under a fixed configuration. The resulting images form the evaluation set 126. The evaluation process 108 then analyzes the color content of each image of the set 126, converts the pixel values to structured color vectors, applies clustering, and computes pairwise similarity metrics between images to determine the degree of internal consistency in color composition, in the form of the color alignment score 130.

In an alternative embodiment, color information may be included in the prompt, either through user input or system configuration. For example, a template might define a placeholder for a color list, and that field may be populated with a set of branding or style guideline colors (e.g., [#C1C1C1, #5E88F1, #A7D7C5]). A resulting prompt might read:
“Generate a visually compelling cover image for a digital learning course titled ‘Introduction to Project Management Essentials.’ The image should reflect the course topic and use the following colors: #C1C1C1, #5E88F1, #A7D7C5. Do not include any text or human figures.”

As in the color-agnostic case, this prompt is submitted multiple times to the image generation model 118 and the resulting images are evaluated for internal consistency. The alignment score 130 generated in this scenario offers a complementary perspective to reference-based evaluation: it reflects whether the model applies the specified colors consistently across generations, not just whether each image individually includes them. When spatial information is used to determine consistency, as will be further described, the system may detect that one image features a large blue region while another distributes blue as a background gradient, resulting in inconsistent visual tone even though both nominally contain the same color.

Disclosed techniques support both this structured-template approach and simpler scenarios in which a static prompt is supplied directly without further combination. Regardless of prompt structure or the presence of color terms, the evaluation process 108 proceeds in the same manner, measuring intra-prompt consistency to assess the stability and repeatability of the output.

Once the prompt has been constructed, the evaluation process 108 can apply one or more preprocessing operations 120 to prepare the prompt for submission to the image generation model 118. Preprocessing at 120 can include normalizing the formatting of color references, such as converting named colors into hexadecimal or RGB triplet notation. It can also involve expanding acronyms, translating non-English text into a preferred model input language, inserting system-defined constraints or modifiers, and adjusting phrasing to reduce ambiguity or increase prompt adherence. When prompt length exceeds the model's token limit, preprocessing at 120 can involve trimming or compressing the input without removing semantically important content. Any preprocessing operations 120 are applied consistently across all submissions within the evaluation batch-a particular iteration of the evaluation process 108.

The processed prompt is then submitted to the text-to-image generation model 118. Some examples of these models 118 operate by converting text into a latent vector representation and generating an image conditioned on that representation. Text encoding is performed using a language model, often based on a transformer architecture. The encoded prompt is passed to a generative model that synthesizes an image from either random noise, discrete tokens, or another latent representation. Some models 118 generate low-resolution images that are upsampled in a separate decoding stage, while others produce full-resolution images directly.

The evaluation process 108 supports the use of a wide range of text-to-image generation models, including those based on diffusion, autoregressive, adversarial, or hybrid architectures. Examples include Stable Diffusion, which performs iterative denoising in a VAE-compressed latent space conditioned on CLIP text embeddings; DALL·E2, which combines CLIP with a diffusion decoder; and DALL·E3, which introduces improved prompt parsing and semantic fidelity through a GPT-based frontend. DeepFloyd IF generates high-resolution outputs through a multi-stage diffusion cascade using T5 embeddings. Imagen uses a large language model as a text encoder and combines it with a super-resolution diffusion decoder. Parti represents an autoregressive approach that tokenizes images and generates sequences of image tokens based on text inputs. Midjourney is believed to use a proprietary diffusion model with weighted token guidance to optimize for visual aesthetics. Other models include CogView2, which uses a transformer architecture to autoregressively generate image patches, and Kandinsky, which combines CLIP and diffusion guidance using a shared latent space. Additional techniques such as DreamBooth, LoRA, and ControlNet are used with base models to impose further structure, personalization, or external control. The model 118 can be used in a variety of ways as a tuning parameter, such as where the evaluation process switches between models during the evaluation process if the alignment score is unsatisfactory or if a particular model is known to handle certain prompt types more reliably. Additional evaluation can be performed to determine whether changing the model 118 provides improved color alignment scores 130.

After the image is generated, the evaluation process 108 can optionally apply post-processing operations 122, such as to standardize the output and prepare it for consistency analysis. Examples of post-processing operation 122 include resizing to a fixed resolution, converting to a consistent color space such as linear RGB or LAB, or cropping or padding to meet expected aspect ratios. Additional processing operations 122 can include contrast normalization, brightness adjustment, noise filtering, and the removal of watermarks or other model-generated overlays. When postprocessing 122 incorporates spatial analysis, the image is divided into a regular grid for localized color assessment. Format conversion is also performed as needed during post processing at 122, such as converting image files into raw pixel arrays or numerical matrices for use in downstream clustering operations.

The image generation process—including preprocessing, prompt submission, image synthesis, and post-processing—is applied identically to each image in the evaluation batch. Variability across the batch reflects the behavior of the image generation model under repeated execution with fixed inputs, not changes in the way the system handles those inputs. This allows for isolation of the effects of the model's internal nondeterminism, to measure how stable its interpretation of the prompt is with respect to color composition.

After the image generation process has been completed for all submissions in an evaluation batch (a particular iteration of the evaluation process 108 for multiple submissions of a prompt keeping other potential variables constant), the resulting images 126 are evaluated to determine whether they exhibit consistent color characteristics based on analyzing the color alignment score 130 at 138. The goal of this analysis is to measure the degree of alignment in the model's interpretation of the prompt with respect to color usage across multiple independent generations. This provides insight into the stability of the model configuration and prompt formulation, even in the absence of any external reference.

To perform this analysis, in generating the color alignment score 130, the evaluation process 108 each image in the set 126 into a set of structured color data. Each image is represented as a collection of color vectors, where each vector corresponds to the color value of a single pixel. The color vectors may be expressed in a number of different color spaces depending on the configuration. In many cases, pixels are encoded in RGB space, where each pixel is described by a red, green, and blue intensity value. However, other color spaces may be used in place of or in addition to RGB. For example, pixels may be converted to LAB space to more closely reflect perceptual similarity, or to HSV space to separate hue and saturation from brightness. In some implementations, distance functions used in clustering or scoring are computed in LAB space even if the clustering itself is performed in RGB or HSV coordinates. The choice of color space affects the sensitivity of the alignment metric to differences in luminance, chroma, and saturation, and may be selected based on the desired tradeoff between perceptual accuracy and computational simplicity.

Once a consistent representation has been established, the full set of pixel vectors for each image is analyzed to identify dominant colors and their relative prominence. This is accomplished through clustering. For each image, a clustering algorithm groups the pixel vectors into a set of clusters, where each cluster represents a major color region within the image. The result is a set of cluster centroids, representing the dominant colors, and associated population counts, reflecting the number of pixels assigned to each cluster.

After clustering has been completed for each image, determining the color alignment score 130 can be carried about by evaluating the similarity between the images by comparing their respective clusters. Each cluster from one image is compared to each cluster from another image to determine how similar the dominant color regions are. These comparisons take into account the positions of the centroids in the selected color space, as well as the relative sizes of the clusters. To help the analysis reflect the visual dominance of each color, similarity scores can be weighted based on the number of pixels assigned to each cluster. Larger clusters contribute more heavily to the overall alignment score than smaller or outlier clusters. These comparisons are aggregated across all image pairs in the evaluation batch to produce a single alignment score 130 for the prompt and configuration under test.

This score 130 reflects how consistently the model 118, when held in a fixed configuration, interprets the prompt in terms of color. A high alignment score 130 indicates that the model 118 generates images with similar dominant colors and distributions across runs, while a lower score suggests that the output varies significantly from one generation to the next. The alignment score 130 can be used as a basis for further refinement of the prompt, model settings, model, or pre- or -postprocessing operation, or as a validation check in automated workflows that require stable and predictable output characteristics.

Once the alignment score 130 has been computed for a given prompt and generation configuration, the evaluation process 108 compares the score to a predetermined threshold value at 138. This threshold defines the minimum level of consistency required for the configuration to be considered acceptable. The threshold may be fixed across all use cases or selected dynamically based on application-specific criteria. For example, a higher threshold may be used in contexts that demand high visual uniformity, while a lower threshold may be acceptable for exploratory or creative applications where greater variation is tolerable.

If the alignment score 130 meets or exceeds the threshold, the current configuration is treated as stable with respect to color consistency, and the system saves the configuration for future use at 142. The saved configuration may include the final prompt or prompt template, any preprocessing rules 120 applied to the prompt, the identity and version of the text-to-image model 118 used, and any post-processing parameters 122 applied to the image outputs. This configuration can then be used in the inference phase 110 to generate one or more images with a high expectation of color consistency, without the need to re-run the evaluation process 108. If no configuration produces an acceptable score within a defined number of iterations, the evaluation process 108 may terminate or fall back to a default configuration.

If the alignment score 130 falls below the threshold, the configuration used in that iteration of the evaluation process 108 is treated as unstable, prompting a refinement cycle aimed at improving consistency across generations. This refinement may involve making changes to one or more components of the configuration, including the prompt template 114 or constructed prompt, the preprocessing operations 120 applied prior to prompt submission, the selection of the text-to-image model 118 used to generate images, or the post-processing steps 122 applied to the model outputs. One or more such modifications are applied, and the resulting configuration is re-evaluated using the same procedure. The evaluation process then proceeds iteratively-repeating this cycle of adjustment and scoring-until the alignment score 130 exceeds the threshold or a maximum number of iterations has been reached.

The evaluation process 108 is configured to allow for automatic or semi-automatic adjusted to identify prompt and generation configurations that produce consistent outputs, without relying on human judgment or external references. The score comparison step 138 acts as a gating mechanism that determines whether the configuration is suitable for use in downstream generation workflows or requires further adjustment.

When the alignment score 130 for a given configuration falls below the consistency threshold, one possible avenue for adjustment is modification of the prompt or prompt template, such as the use case prompt 114. These modifications may target specific weaknesses in the prompt's ability to elicit repeatable color usage from the image generation model. Because text-to-image models 118 rely on complex, often opaque mappings between textual input and visual output, even small changes to wording, structure, or emphasis can produce meaningful differences in how color is interpreted or applied.

Prompt modifications may be applied at the level of a prompt template, where fixed instructional language or placeholders are revised, or at the level of the constructed prompt, where specific field values or user-supplied text are modified. In either case, the goal is to reformulate the input in a way that increases the probability that the model will produce consistent color outputs across multiple independent generations.

One class of modifications involves clarifying or reinforcing implicit color guidance. For example, if the original template includes a phrase such as “generate a cover image for a professional course,” the word “professional” may be interpreted differently across generations and may not lead to a consistent visual palette. Adding specificity—such as “generate a cover image with muted tones and a neutral background to convey a professional aesthetic”—can influence the model to anchor its outputs around a narrower color range. Alternatively, replacing abstract descriptors with concrete references, such as substituting “visually appealing” with “visually appealing in a modern, blue-themed style,” may help steer the model toward more predictable color outputs.

Changes can also be made to strengthen or soften color instructions when such guidance is already present. For example, if the original prompt says “use the following colors: #C1C1C1, #5E88F1, #A7D7C5,” but consistency is low, the system may modify the prompt to state “emphasize the use of the following colors” or “make the following colors visually dominant.” Conversely, if over-weighting the color instruction causes stylistic rigidity or clashes with the image subject, the system may adjust the language to reduce emphasis, such as changing “use the following colors” to “include elements in the following colors where appropriate.” These changes affect not only the likelihood that the colors will appear, but also how consistently they are integrated into the image composition.

In cases where prompts reference multiple conceptual elements—such as a topic, a desired mood, and a visual constraint—the evaluation process 108 may adjust the ordering or phrasing of those elements to influence how the model 118 allocates representational capacity. For instance, a prompt stating “Generate an image that conveys energy and excitement for a training course titled ‘Advanced Sales Strategy’ may lead to more visually diverse outputs than one stating “Generate an image with warm, saturated tones to convey energy and excitement for a training course titled ‘Advanced Sales Strategy.’” By explicitly associating the emotional tone with color characteristics, evaluation process 108 can increase the likelihood of convergence across generations.

Templates may also be adjusted structurally to impose more uniform formatting. If prompts generated from a template include optional fields or vary in syntactic structure depending on user input, the evaluation process 108 may revise the template to produce a more rigid or minimal output. Reducing the degrees of freedom in prompt generation can limit unexpected prompt-model interactions and increase consistency.

Additional changes may involve replacing open-ended instructions with more prescriptive alternatives. For example, instead of “generate a creative background image for the following topic,” the prompt may be changed to “generate a background image in a clean, flat illustration style using a restricted palette.” This type of substitution constrains the stylistic latitude available to the model 118, which in turn can improve repeatability in color usage.

In some cases, the evaluation process may insert or adjust visual metaphors or scene descriptors that are known to correlate with stable color palettes. For instance, changing a prompt from “create a background for a course on leadership” to “create a background for a course on leadership using architectural imagery and natural lighting” may indirectly lead to more color-consistent results, as the added detail guides the model 118 toward narrower visual compositions.

Prompt modifications are intended to influence the model's internal representation of the task in a way that promotes color stability across generations. The revised prompt or template is evaluated under the same procedure as the original, and retained if the resulting alignment score exceeds the threshold. Otherwise, the evaluation process 108 may attempt further revisions, switch to other forms of configuration adjustment, or terminate the optimization process if no further improvements can be achieved.

Another type of configuration change that can be made if the alignment score 130 is below threshold is modifying one or more preprocessing operations 120 applied to the prompt prior to submission to the image generation model 118. These modifications alter the structure, content, or formatting of the prompt without changing the underlying meaning or intent, and can affect how reliably the model 118 interprets the input, particularly with respect to color-sensitive instructions.

One class of preprocessing adjustments involves standardizing or restructuring color-related inputs. When the prompt contains color information, this information may be expressed in various formats, including natural language descriptors, hexadecimal strings, or RGB triplets. If the original prompt contains informal or ambiguous references to color, such as “light blue” or “earth tones,” the preprocessing logic may normalize these expressions into explicit hexadecimal values based on a color dictionary or mapping. Conversely, where the prompt includes raw color codes, the system may convert these into descriptive terms to encourage more semantic interpretation by models that respond better to language-based inputs. For example, a color list such as #5E88F1, #A7D7C5 may be transformed into “a combination of desaturated blue and pale green,” depending on the tendencies of the underlying model.

Preprocessing operations 120 may also be adjusted to vary the placement or salience of color information in the prompt. If color references are buried deep in the prompt structure or placed after more dominant semantic content, the model may inconsistently incorporate them. Moving such information closer to the beginning of the prompt, or isolating it in its own sentence, can help the model assign greater attention to it. For instance, a phrase like “The image should reflect the course topic and use the following colors” may be restructured into “Use the following colors: [list]. Then generate an image that reflects the course topic.” Even if the prompt text remains nominally the same, the reordering performed by preprocessing may significantly influence the model's internal weighting. Similar changes can be made to other tokens in the prompt or prompt template that do not indicate specific color information.

Other adjustments to preprocessing operations 120 may target tokenization and prompt formatting rules. Some image models 118 are sensitive to punctuation, spacing, or casing, and inconsistent formatting can lead to variability in output. Preprocessing 120 may enforce standardized casing (e.g., converting all prompts to sentence case or lowercase), regularize punctuation spacing, or remove characters that are known to reduce prompt fidelity. These changes may appear superficial, but have the potential to reduce unintended differences in prompt interpretation, especially in autoregressive or heavily token-sensitive models.

In multilingual deployments, preprocessing may also include language normalization. When the same prompt template supports multiple languages, the system may standardize all prompts into a single model-optimized language-such as English-prior to generation. Language inconsistency can introduce significant variation in output due to differing lexical embeddings or cultural associations with color.

Additional preprocessing operations 120 may be introduced to incorporate metadata that was not originally present in the prompt. For example, preprocessing operations 120 may detect that a course belongs to a specific category or audience and inject stylistic modifiers associated with that context, such as “designed for executives” or “suitable for technical training.” These modifiers can influence the overall color profile by biasing the model toward certain aesthetics, which may lead to improved consistency across samples. If such metadata-based injection is performed, it may be done conditionally, only in configurations where the baseline alignment score is unsatisfactory.

In cases where a fixed list of preprocessing operations 120 are applied across all prompts, the evaluation process may selectively enable or disable specific steps to measure their impact on consistency. For example, if the preprocessing operations 120 include aggressive abbreviation expansion or color-to-hex translation, these steps can be toggled off in subsequent evaluations to test whether a lighter-touch transformation leads to more consistent results.

Where prompts are constructed from multiple input sources-such as user text, metadata, and templates-preprocessing operations 120 may include prioritization logic to resolve conflicting inputs. If a user selects a specific palette but the course metadata suggests an alternate style, the preprocessing operations 120 may choose one, merge them, or suppress conflicting elements. Reweighting the importance of each input source can affect which color instructions the model perceives as dominant, and thus improve stability when previous prompts produced inconsistent outputs due to implicit conflicts.

Preprocessing modifications are executed in advance of generation and applied consistently to all submissions in the evaluation batch. Each revised preprocessing configuration is evaluated independently using the same consistency scoring process, and is retained only if the resulting alignment score meets or exceeds the configured threshold, or at least improves the alignment score compared with a prior configuration. For example, if one change lead to an improvement, but the threshold was still not satisfied, successful modifications can be retained, and other modifications can be make to try and further improve the color alignment score 130.

Another type of configuration adjustment that can be made is modifying the image generation model 118. These modifications range from switching between entirely different model architectures to adjusting generation-time parameters or altering internal components of the model that influence its behavior.

One approach involves substituting the currently selected model 118 with an alternate model available within the system. Text-to-image models vary significantly in how they interpret prompts, in their visual style, and in the degree to which they respond predictably to descriptive or constraint-based input. Some models prioritize aesthetic composition over semantic adherence, while others strongly enforce prompt alignment but exhibit greater variability in visual characteristics such as color. For example, a model such as Midjourney may exhibit a high degree of visual refinement but respond idiosyncratically to explicit color instructions. In contrast, a model such as DALL·E3 may enforce semantic fidelity more rigidly but apply color information unevenly, particularly when prompts are ambiguous or under-specified. Stable Diffusion and its derivatives tend to expose a broader range of control parameters but may require more precise prompt engineering to achieve consistent results. By switching from one model to another, the evaluation process 108 can test whether the alternative model 118 exhibits more stable color behavior when presented with the same prompt and processing configuration.

In addition to changing the model 118, the evaluation process may adjust one or more generation-time parameters that affect how the model produces images. These hyperparameters may include the number of inference steps used during image synthesis, the temperature or sampling strategy applied during token selection (in transformer-based models), the guidance scale or classifier-free guidance strength used to control prompt conditioning, or other parameters exposed by the model API. For example, increasing the guidance scale in a diffusion model may improve prompt adherence by weighting the semantic embedding more strongly during the denoising process, but may also reduce diversity or lead to over-saturation. Decreasing the guidance scale may allow the model to explore more freely but at the cost of increased output variability. Adjusting these parameters can shift the balance between semantic precision and generative diversity, which may in turn affect color consistency across outputs.

The evaluation process 108 may also modify internal features or control mechanisms that are attached to the model 118 or used during inference. These may include adapter modules or plug-ins such as ControlNet, LoRA weights, textual inversion embeddings, or DreamBooth fine-tunes. For example, if the current configuration uses a model checkpoint that has been fine-tuned for portrait generation, and the prompt does not involve human figures, the evaluation process 108 may revert to a baseline checkpoint or apply a more neutral embedding. Similarly, if a LoRA adapter is active that biases the model toward a specific visual theme or subject matter, it may be removed or replaced to allow for broader prompt interpretation. In some cases, prompt weighting mechanisms such as token emphasis or negative prompting may be adjusted to strengthen or weaken specific prompt components that affect how color is rendered. These internal model features often exert a subtle but meaningful influence on how the model balances color, composition, and style, particularly when prompts are long or contain multiple competing signals.

In some cases, the system may attempt to improve alignment by training or fine-tuning the model using additional labeled data. This data may include prior generations from the same or similar prompts that were previously identified as either color-consistent or inconsistent. For example, if a set of images is known to have passed or failed the alignment threshold, these images can be associated with positive or negative reinforcement labels, respectively. The model may then be trained on this data using techniques such as contrastive learning, reinforcement learning with human feedback, or supervised fine-tuning.

In one implementation, user feedback is collected explicitly by presenting multiple generated images to a reviewer and requesting a binary or graded assessment of whether the set is visually consistent. This feedback is used to build a dataset of image sets paired with consistency judgments, which are then used to adjust the model's internal representations. By training on examples of success and failure, the model may learn to associate specific prompt formulations or latent features with desirable color behavior, increasing the probability that future generations from similar prompts will exhibit greater consistency. This approach is particularly useful in domain-specific deployments where user expectations regarding visual uniformity are not easily captured by fixed rules.

Changes to the model 118, whether through substitution, parameter adjustment, or internal feature modification, are treated as part of the configuration state and are evaluated using the same alignment procedure as other adjustments. Each altered model configuration is held fixed while the same prompt is submitted multiple times, and the resulting images are scored for consistency. If the new configuration yields a higher alignment score than the original, it may be retained and used in subsequent generation workflows. If not, the system may continue iterating through additional model configurations or return to prior stages of the refinement cycle.

The evaluation process 108 may also make changes to the post-processing operations 122 applied to the generated images to try and improve the alignment score. Post-processing operations 122 are applied after image synthesis has completed and are responsible for preparing the image data for downstream analysis, display, or storage. In the context of consistency evaluation, post-processing 122 affects the way image data is interpreted during clustering and scoring, and therefore can influence whether alignment is correctly or reliably assessed.

Post-processing modifications may involve adjustments to the way image resolution, format, or color space is handled prior to analysis. For example, the evaluation process may alter the target resolution to which all images are normalized. If the initial evaluation used a high-resolution output, and clustering exhibited instability due to small regions of color variation, the evaluation process 108 may modify the postprocessing operations 122 to downsample the images to a coarser resolution. This reduces the influence of fine-grained variation and emphasizes dominant color regions. Conversely, if significant color differences are concentrated in small regions that become lost at lower resolutions, the evaluation process 108 can modify the postprocessing operations 122 to increase the resolution used during analysis to capture greater spatial fidelity.

The color space in which clustering is performed may also be changed. Although RGB space is commonly used due to its direct correspondence with pixel data, it does not reflect perceptual uniformity. As a result, small changes in RGB values may correspond to large perceived color differences, or vice versa. The evaluation process 108 may therefore adjust the postprocessing operations 122 to convert images to LAB color space or a similar perceptual color model prior to clustering in order to improve the meaningfulness of distance calculations between color vectors. In some cases, conversions between sRGB, linear RGB, HSV, or HSL may be tested iteratively to determine which space yields more stable or interpretable clustering behavior under a given prompt and model configuration.

Other post-processing operations 122 may involve filtering or normalization of image content. If the model 118 exhibits a tendency to introduce noise, compression artifacts, or oversaturation, the evaluation process 108 may modify the postprocessing 122 to apply smoothing filters, contrast normalization, or histogram equalization to reduce unwanted variation that interferes with alignment analysis. For example, bilateral filtering may be used to reduce color variation in textured areas while preserving edges. Median filtering may be applied to remove pixel-level outliers that distort cluster formation. These steps do not change the semantic content of the image but may reduce spurious differences across generations that would otherwise lower the alignment score.

In implementations that incorporate spatial consistency as part of the alignment analysis, postprocessing operations 122 can include subdividing an output image into a grid, and color alignment is computed independently in each grid cell. If the grid resolution is too fine, it may lead to false negatives due to small shifts in content location. If the resolution is too coarse, it may miss meaningful differences in color placement. The evaluation process may therefore adjust the number of grid cells, the overlap between adjacent cells, or the weighting scheme used to aggregate alignment scores across spatial regions.

The format of the image may also influence how data is handled during clustering. If a prior post-processing operation included quantization to 8-bit RGB or conversion to a compressed format such as JPEG, the evaluation process may replace these steps with lossless representations or higher-precision formats to preserve fine color gradations. Alternatively, where the model 118 produces images with high dynamic range or noisy gradients, the evaluation process may reduce color precision intentionally to stabilize clustering.

Adjustments to postprocessing operations 122 are typically performed without modifying the semantic content of the image and are applied identically to all images in the evaluation batch 126. This uniform treatment helps provide that any changes in alignment score reflect differences in how images are interpreted for scoring, not in the underlying generative content. After each post-processing configuration is applied, the system re-evaluates the prompt and model setup under the revised processing logic, using the same clustering and scoring method. If the new configuration produces an alignment score that meets or exceeds the threshold, it is retained and used in the inference phase. Otherwise, further adjustments may be explored or the evaluation process 108 may be terminated based on system-defined stopping criteria.

As described, once the alignment score 130 for a prompt and configuration has been determined to be below threshold, the system may initiate a sequence of adjustments aimed at improving color consistency. These adjustments may be applied individually, sequentially, or in combination, depending on the system configuration, the characteristics of the prompt, and the observed behavior of the model.

In some cases, the system applies adjustments one category at a time, evaluating the effect of each change independently. Each stage represents a separate iteration within the evaluation process, enabling focused refinement of specific configuration elements. For example, the evaluation process 108 may begin by modifying the prompt or prompt template, then proceed to preprocessing changes if the revised prompt does not result in an acceptable alignment score. If prompt-level and preprocessing adjustments do not yield a sufficient improvement, the evaluation process may alter the model configuration or change the post-processing pipeline. This staged approach allows the evaluation process to isolate the contribution of each component to the overall consistency score 130 and can help reduce the search space when identifying stable configurations.

In other implementations, the evaluation process may apply changes from multiple categories simultaneously. For example, if evaluation process 108 determines that the prompt contains under-specified color instructions and that the model 118 in use is known to exhibit low color fidelity under such conditions, it may revise the prompt and substitute the model in the same evaluation cycle. Similarly, if the model 118 produces consistent color content that is disrupted by post-processing artifacts, the evaluation process 108 may combine a switch to a more neutral post-processing pipeline with changes to the preprocessing logic that emphasize perceptual color descriptors. This parallel adjustment strategy can shorten the number of refinement iterations required to reach a stable configuration, particularly when the failure is believed to arise from interactions among components.

The order in which adjustments are attempted may be predefined, dynamic, or learned. In some cases, the evaluation process follows a fixed adjustment sequence, such as prompt→preprocessing→model→post-processing. In other cases, the order is determined at runtime based on available metadata, system heuristics, or prior evaluation history. For example, if the evaluation process 108 has previously observed that a given model 118 responds strongly to changes in prompt structure but weakly to preprocessing changes, it may prioritize prompt modification. Alternatively, if a low alignment score 130 is accompanied by indicators of noise or artifacting in the output images, the evaluation process 108 may apply post-processing modifications first.

Adjustments can be automated through a combination of rule-based logic, empirical scoring, and language model assistance. For many categories of adjustment, direct automation is feasible. Model substitution, for example, can be performed automatically using a ranked list of candidate models and a configuration file that maps prompt types to preferred model architectures. Generation parameters such as guidance scale, number of inference steps, or denoising strength can be modified in fixed increments, with each variant evaluated using the same consistency scoring procedure. Preprocessing and post-processing steps may be toggled, reordered, or parameterized through configuration templates that the system selects based on prompt features or past performance. This approach is particularly effective in use cases like enterprise learning platforms, where maintaining visual continuity across repeated generations is important for user trust and branding cohesion.

More flexible or open-ended adjustment strategies may rely on language model assistance. For example, the system may construct a judge prompt such as:
“Based on the color alignment results of a set of AI-generated images, revise the use case prompt to take into account more accurate color alignment.
Input data: [original text]
Generated images: [image set]
Color alignment score: [numeric value]
Use case prompt: [original prompt text]”
   This format may be passed directly to a large language model or a vision-language model depending on the deployment.

In some cases, the evaluation process 108 presents a description of the current prompt, alignment score, and evaluation results to a large language model and requests a revised prompt or configuration. The prompt to a language model 148 may include specific guidance, such as “revise the following prompt to improve color consistency across generated images” or “restructure the prompt to emphasize dominant color regions.” The evaluation process 108 may also include candidate modification points, such as alternative color descriptions, synonyms for stylistic terms, or reordered sentence fragments. The language model 148 returns a revised prompt or set of changes, which the evaluation process applies and evaluates.

In an alternative implementation, the language model 148 is a vision-language model that is used to assist with prompt revision. In addition to the text-based context described above, the evaluation process 108 supplies a representative set of generated images from the most recent evaluation, along with a prompt or instruction set describing the consistency issue. For example, the model 148 may receive the original prompt text, an instruction such as “revise this prompt to produce images with more consistent use of saturated accent colors,” and a batch of images that failed to meet the alignment threshold. The vision-language model 148 can analyze both the textual input and the visual characteristics of the failed outputs and return a revised prompt or configuration intended to improve consistency. Because the model 148 has access to actual image data, it can detect subtle discrepancies between prompt intent and output appearance that might be difficult to infer from text alone. This variation is particularly useful when color inconsistencies relate to spatial layout or nuanced visual interpretation.

These language- and vision-assisted adjustment mechanisms provide a flexible way to refine prompts and configurations in cases where direct rule-based changes are insufficient or where the source of inconsistency is context-dependent. They also enable the evaluation process 108 to generate human-readable rationales for the adjustments made, which may be logged or reviewed as part of an optional audit or QA process. The evaluation process 108 may also retain the full history of judge or optimization prompts used to revise prior configurations, enabling traceability and explainability of model adjustments.

In some implementations, the evaluation process 108 maintains a log of adjustments attempted and their corresponding alignment scores. This history is used to avoid repeating ineffective changes and to identify patterns in which certain combinations of adjustments yield positive outcomes. The evaluation process may further apply gradient-free optimization techniques, such as random sampling, grid search, or Bayesian optimization, to search the adjustment space in a structured but model-agnostic manner.

Whether applied individually, sequentially, or in combination, all adjustments are tested through re-evaluation of the prompt and configuration using the same batch generation and scoring procedure. Once a configuration is found that exceeds the alignment threshold, it is retained as the optimized configuration for use in the inference phase. In other cases, evaluation can continue for additional iterations to determine if a higher alignment score can be achieved, or whether the score remains high for a larger set of test inputs. If no configuration produces a satisfactory score within the allowed number of iterations, the process may terminate or fall back to a default configuration based on closest alignment score achieved.

Once a configuration has been determined by the evaluation process to produce images with sufficient color consistency, the inference phase 110 can be carried out. In the inference phase 110, the previously selected configuration—consisting of the prompt template, preprocessing logic, image generation model, generation—time parameters, and post-processing procedures—is used to generate final images without additional evaluation or refinement.

During the inference phase 110, a new input 156 is received, which may include user-supplied or process-generated content such as a course title, subject tag, or optional color input. This content is combined with the previously selected prompt template 114 using the same construction process as during evaluation. Preprocessing 120 is applied according to the finalized ruleset, and the resulting prompt is submitted to the selected image generation model 118 using the stored configuration parameters. The model 118 generates one or more output images, which are then post-processed according to the same pipeline used during the evaluation process. In the event multiple images are generated, the evaluation process 108 can performed on such images. This can help ensure that alignment scores 130 remain above the desired threshold over time and disparate inputs.

In other cases, the inference phase 110 does not involve computation of an alignment score or comparison of outputs against a reference or prior image set. Instead, it assumes that the evaluated configuration will produce consistent results when applied to comparable inputs. The inference phase 110 may generate a single image 160 or a batch of images depending on application requirements. The final output is passed at 164 to the downstream application or stored for further use.

### Example 3—Example Prompt Generation

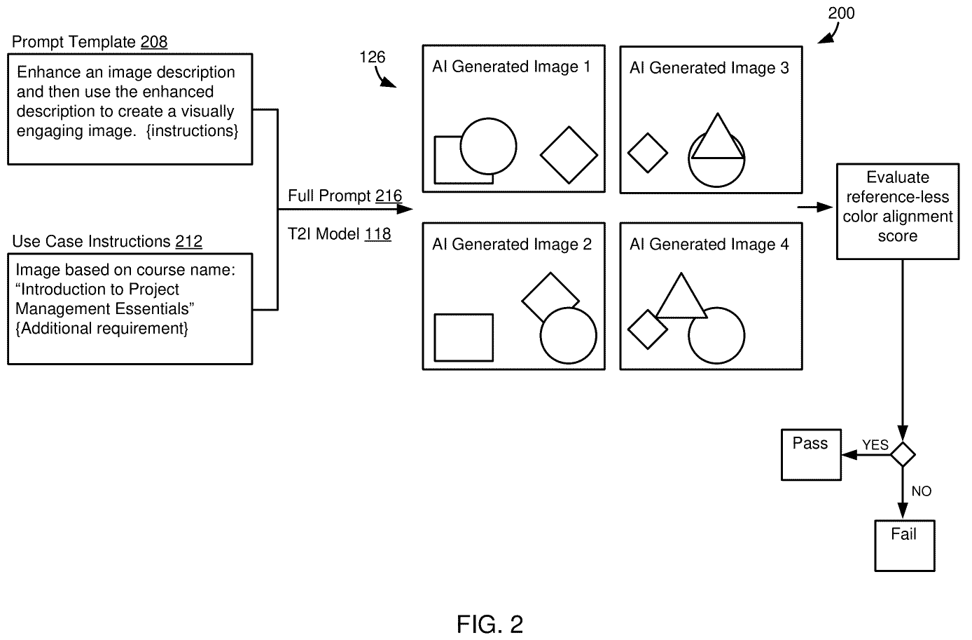

FIG. 2 provides a more detailed example process 200 of how prompts can be generated during the evaluation process 108 of FIG. 1. Although FIG. 2 only shows the evaluation process, prompts for the inference phase can be generated in an analogous manner.

The process 200 of generating a full prompt 216 begins with a layered construction pipeline that allows both generalized structure and context-specific detail to be expressed in a controlled and repeatable way. At the top level, the process 200 uses a prompt template 208 that provides a stable semantic framing for the prompt as a whole. This template 208 typically includes one or more placeholder fields, such as an insertion point for use case-specific instructions or modifiers, which are populated during runtime.

Use case instructions 212 may be defined using a secondary template or scaffolding structure. This inner structure includes its own placeholders, into which user-supplied or system-derived values are injected. These values may represent high-level contextual content, such as a course title, product name, or subject matter domain, along with additional modifiers that reflect visual constraints, stylistic preferences, or branding goals. The following pseudocode illustrates this layered construction flow:

```
# User- or system-supplied values
course_title = “Introduction to Project Management Essentials”
additional_requirements = “Do not include any human figures.”
# Inner scaffolding: instruction block template
instruction_template = (
  “Image based on course title: \”{course_title}\“. ”
  “{additional_requirements}”
)
# Construct instruction block
instruction_block = instruction_template.format(
  course title=course title,
  additional_requirements=additional_requirements
)
# Outer prompt template
prompt_template = (
  “Enhance an image description and then use the enhanced description ”
  “to create a visually engaging image. The color should be suitable ”
  “for a technical lecture style. {instructions}”
)
# Final prompt construction
final_prompt = prompt_template.format(instructions=instruction block)
```

This structure allows the process 200 to preserve a high degree of prompt regularity at the top level, while varying or tuning specific fields that have been empirically shown to influence output behavior. For example, alignment accuracy can often be improved by refining the AdditionalRequirement field to provide more explicit guidance on tone, color usage, or composition. In many cases, the AdditionalRequirement includes tweaks previously introduced during prompt refinement iterations, such as specifying a limited color palette, describing lighting conditions, or requesting a particular visual mood. These refinements may reflect learned responses to model behavior—for example, observing that the inclusion of “muted tones” or “cool lighting” increases consistency across generations.

Adjustments may also be made to the structure or language of the outer prompt template itself. While this template tends to be relatively stable, small changes—such as reordering clauses, breaking complex instructions into simpler sentences, or adding transitional phrases—can affect how the model interprets and weights different components of the input. For instance, separating the instruction to enhance the description from the instruction to generate the image may lead to more predictable behavior than phrasing them as a compound task. Similarly, repositioning where the use case instructions appear within the overall prompt may influence how much attention the model assigns to that portion of the text.

During the process 200, the full prompt—assembled through this layered process—is submitted multiple times to the text-to-image model 118 to generate the set of images 126 of FIG. 1. Components of the configuration are held constant across submissions, including the final assembled prompt, and uses the resulting image set to compute the color alignment score. Remaining aspects of the process 200 can be analogous to the evaluation process 108. Although this process 200 is part of the configuration and tuning loop, the same prompt construction logic is used during inference to generate final images from newly supplied course titles, user inputs, or programmatic values.

### Example 4—Examiner Color Alignment Score Calculation

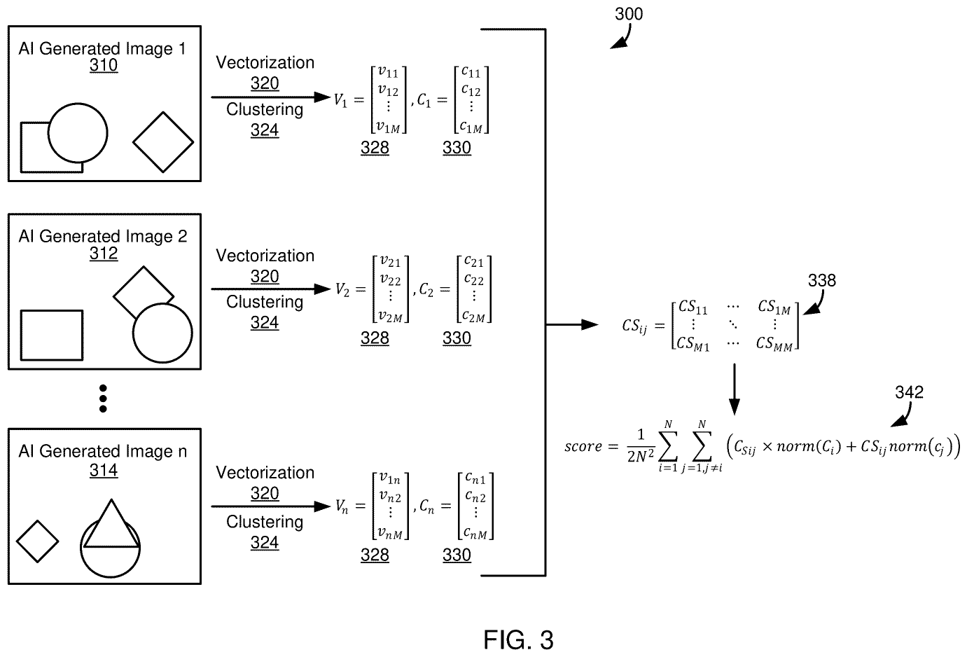

In a specific implementation of disclosed techniques, the color alignment score is calculated from a set of images that have been generated from a common prompt under a fixed configuration. The set of images is illustrated in FIG. 3 as images 310, 312, 314. This score provides a quantitative measure of how consistent the images 310-314 are in their use of color, without relying on any reference image or external palette. The scoring process operates on the generated images themselves, making it applicable in scenarios where the desired color characteristics are implicit, unknown, or emergent from the prompt.

A calculation process 300 begins with vectorization of each image 310-314 at 320. Each pixel in the image is converted to a vector that encodes its color values. In the default implementation, this is performed in RGB space, where each pixel becomes a three-element vector [R,G,B] with integer values between 0 and 255 for 8-bit encoding. This representation captures the full 3D color space in a format that is suitable for clustering and similarity scoring. In alternative implementations, color vectors may be expressed in different color spaces, such as LAB, HSV, or linear RGB. These alternatives may be used where perceptual uniformity is important or where model outputs are known to behave inconsistently in RGB space.

Once each image has been vectorized, clustering is performed on the resulting color vectors at 324 to identify the dominant color regions within the image. The default clustering algorithm is K-means, which groups the vectors into M clusters by minimizing intra-cluster variance. Each cluster is characterized by:
A centroid vₙₖ∈ [symbol] ³, representing the mean RGB value of all pixels assigned to cluster k in image n, and
A cluster population count cₙₖ, representing the number of pixels in that cluster.

These values are collected into two matrices for each image, also shown in FIG. 3 as matrices 328, 330:

$${V}_{n} = [ \begin{matrix}{v}_{n 1} \\ {v}_{n 2} \\ ⋮ \\ {v}_{nM}\end{matrix} ] , {C}_{n} = [ \begin{matrix}{c}_{n 1} \\ {c}_{n 2} \\ ⋮ \\ {c}_{nM}\end{matrix} ]$$

Where vₙ contains the RGB centroids of all the RBG centroids for all M clusters for image n, and Cₙ contains the corresponding pixel counts.

Alternate clustering approaches may be used in place of K-means. For example, DBSCAN can be used to find clusters of arbitrary shape, particularly in images with less distinct color regions. Mean shift clustering or Gaussian mixture models may also be employed where more nuanced representations of color variation are desired. The number of clusters M may be fixed or selected dynamically based on image complexity or pixel distribution.

After clustering is complete for all images, pairwise similarity matrices are computed to compare the color centroids across images. For each pair of images i and j, a similarity matrix Cₛᵢⱼ∈ [symbol] ^{M×M} is constructed, where the entry csₖᵢ represents the similarity between cluster kin image i and cluster/in image j. The default similarity function is cosine similarity, which is calculated as:

$${CS}_{kl} = \frac{{v}_{ik} \cdot {v}_{ij}}{‖ {v}_{ik} ‖ ‖ {v}_{jl} ‖}$$

This score ranges from −1 to 1, with higher values indicating closer alignment in color space. In RGB and most perceptual color spaces, color vectors are non-negative, so cosine similarity typically falls in the range [0,1], where 1 indicates exact matching in direction (i.e., same color regardless of magnitude). Alternative similarity metrics may be used, including Euclidean distance, Mahalanobis distance, or perceptual color difference metrics such as ΔE, depending on the application context.

Each computed similarity value CSₖₗ is inserted into the matrix CSᵢⱼ 338 at row k, column l, k indexes clusters from image i, and I indexes clusters from image j. As a result, CSᵢⱼ∈ [symbol] ^{M×M} encodes the full pairwise similarity relationships between the dominant color clusters of the two images. In the matrix, rows and columns represent clusters and entries represent their similarity scores.

$${CS}_{ij} = [ \begin{matrix}{CS}_{11} & … & {CS}_{1 M} \\ ⋮ & ⋱ & ⋮ \\ {CS}_{M 1} & … & {CS}_{MM}\end{matrix} ]$$

To account for the visual prominence of each cluster, the similarity scores are weighted based on the relative size of the clusters being compared. Cluster sizes are normalized using the [symbol] ₁-norm to ensure that they represent relative proportions rather than raw counts. The normalized cluster size vector for image nis defined as:

$$norm ( {C}_{n} ) = \frac{{C}_{n}}{{\sum }_{k = 1}^{M} {c}_{n k}}$$

The final color alignment score is calculated by aggregating the pairwise similarity matrices across all image pairs and applying the corresponding normalized cluster weights. The equation 342 is:

$$score = \frac{1}{2 {N}^{2}} {\sum }_{i = 1}^{N} {\sum }_{j = 1 , j \neq i}^{N} ( {CS}_{ij} \times norm ( {C}_{i} ) + {CS}_{ij} \times norm ( {C}_{j} ) )$$

This formula captures the average color similarity between all images in the set, with each cluster's contribution weighted according to its visual importance. The resulting score is a scalar value that reflects the internal alignment of the image set. When cosine similarity is used and all vectors are non-negative, the score lies in the range [0,1], where 1 indicates perfect alignment of dominant color regions across all images, and lower scores indicate increasing variation.

The alignment score is computed without any reference to a user-defined target image, palette, or external ground truth. It is a reference-agnostic metric that evaluates consistency based on the model's internal response to a single prompt. This enables it to be applied in zero-shot settings, during exploratory prompt engineering, or in automated tuning loops where no reference is available or desired.

The color alignment score forms the basis for determining whether a configuration is sufficiently stable to be used in downstream inference. Configurations that yield high scores are assumed to produce repeatable, internally coherent outputs, while those with low scores may require refinement to reduce variability in color expression.

In addition to the clustering-based approach described above, alternative techniques may be used for representing and comparing the color composition of generated images. These techniques extract structured features related to color distribution without relying on unsupervised clustering algorithms and may be used in environments where interpretability, performance, or compatibility with existing components is prioritized.

In one implementation, a color histogram is constructed for each image. A color histogram is a fixed-length vector that captures the distribution of pixel colors by counting the number of pixels falling into discrete bins in a selected color space. The histogram may be computed independently for each channel—for example, with separate histograms for red, green, and blue channels in RGB space—or jointly using multidimensional bins that encode color tuples. The granularity of the bins can be chosen based on application requirements. For example, histograms in LAB color space may use finer divisions to better capture perceptual differences.

To compare two images using this approach, a similarity score between the respective histograms is calculated. Suitable similarity metrics include cosine similarity, which compares the angle between normalized histogram vectors; histogram intersection, which sums the minimum values across corresponding bins; Earth Mover's Distance, which calculates the minimum work needed to transform one histogram into another; and divergence-based metrics such as Kullback-Leibler or Jensen-Shannon divergence, which treat the normalized histograms as probability distributions. Once the pairwise histogram similarity scores have been calculated, they are aggregated across image pairs in the evaluation batch to compute a global color alignment score. This score may be used directly or combined with weighting schemes that reflect the total energy or salience of particular bins.

In another variation, statistical color moments are calculated for each image, including the mean, standard deviation, and optionally higher-order moments such as skewness. These moments may be computed per channel or jointly depending on the color space. The resulting moment vectors provide a compact, global summary of the image's color profile. The moment vectors of different images can be compared using a distance function such as Euclidean distance, Mahalanobis distance, or cosine similarity. This technique is computationally efficient and may be suitable for coarse-grained assessments of color tone and dispersion, though it may be less sensitive to multimodal or spatially localized variation.

In a further implementation, learned feature embeddings are used to characterize the color content of images. These embeddings may be extracted using a pretrained neural network model, such as a convolutional neural network or a vision-language transformer, applied to the generated image. The technique can use intermediate feature maps, pooled token representations, or fully connected layer outputs as the embedding vector. Because these learned representations capture a combination of semantic and visual features, they may implicitly encode color composition in addition to other stylistic attributes. Image similarity is then calculated using cosine similarity, inner product, or another vector distance measure. This technique may be especially effective when color alignment is considered in the context of higher-level visual coherence.

In implementations that incorporate spatial awareness, any of the foregoing techniques may be applied on a localized basis. The image may be divided into a grid of regions, and histograms, color moments, or embeddings may be computed separately for each region. The technique then performs pairwise similarity comparisons on a per-region basis and aggregates the results to produce a global alignment score. This allows the system to distinguish between images with the same global color distribution but different spatial arrangements—for example, whether a dominant color appears in the background, foreground, or a confined area of the frame.

Selection of a specific technique can be based on configuration settings, resource constraints, or the specific characteristics of the image generation model in use. The alignment scoring pipeline may include pluggable modules for color feature extraction, similarity comparison, and score aggregation, enabling different strategies to be tested or deployed depending on the context. These alternative approaches may be used independently of clustering or combined with clustering-based methods to produce hybrid alignment scores.

In further variations, alignment scoring may be performed without explicitly computing similarity values between pairs of images. In these implementations, the evaluation process evaluates color consistency across the full set of images using aggregated or global distribution measures that capture variation across the batch as a whole. One such approach involves computing a central color representation, such as the average histogram, centroid set, or color moment vector across all images in the evaluation batch. The alignment score is then derived from the dispersion of individual image-level features relative to this central representation.

For example, the evaluation process may compute the variance, standard deviation, or mean squared error between the color features of each image and the batch-level average. Lower dispersion indicates stronger agreement in color usage across the batch, resulting in a higher alignment score. This approach can be more efficient compared with pairwise comparisons.

Another implementation applies dimensionality reduction techniques to the set of color distribution features extracted from each image. In one example, the evaluation process uses principal component analysis (PCA) to project each image's color histogram or embedding vector into a low-dimensional space. The dispersion of these projected points, such as their variance along principal axes or their distance from the centroid of the projected distribution, is used to quantify alignment. A compact, tightly clustered distribution indicates high color consistency across the image set, while broad dispersion or multimodal clusters suggest variability in how the prompt was interpreted. Other dimensionality-reduction methods may be used in place of PCA, including t-SNE, UMAP, or autoencoder-based projections, depending on the structure of the feature space.

In yet another approach, the evaluation process performs clustering not on individual images, but on the combined set of color vectors from all images in the evaluation batch. This global clustering operation partitions the entire collection of pixel vectors into shared color groups. The consistency of these clusters is then assessed using metrics such as cluster purity, silhouette score, or entropy. If the same set of dominant color clusters emerges across all images, the resulting score will be high. If different images pull the global clustering in incompatible directions—resulting in fragmented or overlapping clusters—the score will be lower. This implementation captures commonality in overall color usage without requiring image-by-image segmentation.

A related implementation models the batch of images as a graph, where each image is represented as a node and edges encode similarity or distance in color composition. The evaluation process may compute global structural metrics such as graph density, average path length, modularity, or clustering coefficient to characterize the alignment of the image set. For example, a tightly connected graph with uniformly high edge weights indicates strong agreement in color features, while sparse or highly variable connectivity suggests color inconsistency. This technique may be particularly effective in visualizing or interpreting consistency across large image sets or when combined with metadata-aware graph construction (e.g., grouping images by sub-prompt, region, or generation condition).

These alternative approaches allow the system to calculate a color alignment score that reflects batch-level coherence without relying on explicit pairwise comparison. In some implementations, such techniques may be used as a replacement for traditional pairwise scoring. In others, they may be combined with clustering-based or histogram-based approaches to produce hybrid metrics that capture multiple dimensions of consistency. The evaluation process may select among these strategies dynamically based on image set size, prompt complexity, or runtime performance constraints.

### Example 5—Example Spatially Aware Color Alignment Score Determination

In some cases, evaluating color consistency based solely on the global color distribution may not fully capture the perceptual coherence of a set of images. Although two images may contain similar dominant colors in similar proportions, the spatial arrangement of those colors may lead to very different user impressions. For example, if one image contains a blue tone evenly distributed across the entire image and another image contains the same amount of blue concentrated in a small corner, both may receive similar scores under the global color alignment metric, but may appear perceptually inconsistent to a viewer. To address this scenario, a spatially aware variation of the scoring method can be used.

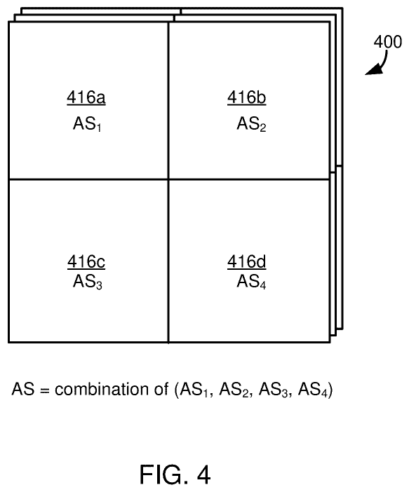

This variant augments the color alignment metric by incorporating local color distribution analysis. As illustrated in FIG. 4, each images of a set of generated images 400 is divided into a fixed-resolution grid, such that the image is broken into smaller, non-overlapping tiles. For example, the image may be subdivided into a 10×10 grid, resulting in 100 equally sized rectangular regions. For simplicity, FIG. 4 illustrates a 2×2 grid, with grid cells 416a-416d. Each grid cell is treated as an independent region, and color vectorization and clustering are performed within each region as though it were a separate image. This produces a set of local cluster centroids and pixel counts for each grid cell, analogous to the Vₙ and Cₙ matrices used in the global version of the scoring method. As shown, each grid cell 416a-416d has a corresponding color alignment score A Sₙ.

Once grid subdivision has been performed for all images in the evaluation batch, corresponding grid cells across all image pairs are compared. That is, the cell in row r, column c in one image is compared to the same cell in another image using the same pairwise clustering and similarity scoring method described previously. Each cell-level score reflects the local alignment of color content in that spatial region. These local scores are then aggregated to produce a final spatial alignment score AS for the image pair or batch 400. This score reflects not only the similarity in color composition, but also the consistency in where those colors appear across images.

The spatial consistency score can be integrated in several ways. In one implementation, the global score and the spatial score are computed independently and combined using a weighted average, allowing the system to balance color similarity and spatial coherence. In another, the spatial score may be used as a separate thresholding criterion, requiring both global and spatial alignment scores to meet configured thresholds before a configuration is accepted. In a third approach, the spatial score may be treated as an enhancement: when the global score is close to threshold, the spatial score is used to resolve borderline cases.

Several variations on the grid-based approach may be employed depending on application constraints. The resolution of the grid may be adjusted dynamically based on image size, complexity, or model variability. Coarse grids (e.g., 5×5) reduce sensitivity to small shifts in color placement, while finer grids (e.g., 16×16) capture more detailed spatial patterns. Overlapping grid cells may be used to smooth sensitivity to boundary effects. The system may also apply spatial weighting, giving more importance to certain regions (e.g., central cells or upper quadrants) when known to influence user perception more strongly.

The spatial extension preserves the reference-agnostic nature of the alignment score. No external template or palette is required; instead, the scoring is based on internal consistency across corresponding spatial regions of the generated images. This makes the method suitable for applications where visual balance and layout coherence are important, such as UI asset generation, presentation templates, or learning content with fixed framing. The spatial scoring process can be enabled or disabled based on prompt type, content domain, or system configuration.

### Example 6—Example Operations

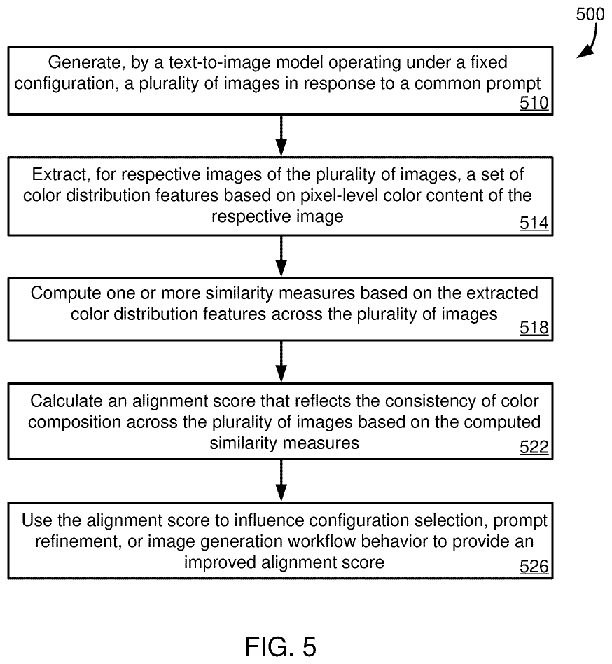

FIG. 5 is a flowchart of a process 500 for evaluating color consistency in image generation and using an alignment score to guide configuration refinement.

At 510, a plurality of images is generated by a text-to-image model operating under a fixed configuration in response to a common prompt. At 514, for respective images of the plurality of images, a set of color distribution features is extracted based on pixel-level color content of the respective image. One or more similarity measures are computed across the plurality of images based on the extracted color distribution features at 518.

At 522, an alignment score is calculated that reflects the consistency of color composition across the plurality of images based on the computed similarity measures. The alignment score is used at 526 to influence configuration selection, prompt refinement, or image generation workflow behavior, in order to provide an improved alignment score.

### Example 7—Additional Examples

Example 1 is a computing system that includes at least one memory, one or more hardware processor units coupled to the at least one memory, and one or more computer-readable storage media. The computer-readable storage media include computer-executable instructions that, when executed, cause the computing system to perform operations. The operations include generating, by a text-to-image model operating under a fixed configuration, a plurality of images in response to a common prompt. A set of color distribution features is extracted for each image based on the pixel-level color content of that image. One or more similarity measures are computed across the images based on the extracted features. An alignment score is calculated that reflects the consistency of color composition across the set. The alignment score is used to influence configuration selection, prompt refinement, or image generation workflow behavior, to provide an improved alignment score.

Example 2 is the computing system of Example 1, where the color distribution features are extracted by converting pixel values of each image into color vectors in a selected color space.

Example 3 is the computing system of Example 1 or Example 2, where using the alignment score to influence configuration selection includes modifying one or more of a prompt template, preprocessing logic, image generation model, or post-processing configuration.

Example 4 is the computing system of Example 3, where modifying the image generation model includes switching to a different text-to-image model architecture or adjusting one or more generation-time parameters.

Example 5 is the computing system of any of Examples 1-4, where configuration refinement is performed iteratively until the alignment score satisfies a predefined consistency threshold or a termination condition is met.

Example 6 is the computing system of any of Examples 1-5, where using the alignment score includes producing an optimized image generation configuration that is used in a downstream inference phase.

Example 7 is the computing system of Example 6, further including receiving a request to generate an image associated with a new prompt input. The prompt input is processed according to the optimized image generation configuration, and the generated image is returned in response to the request.

Example 8 is the computing system of Example 7, where the optimized image generation configuration includes a prompt template, a selected model, preprocessing and post-processing parameters, and one or more generation-time model settings.

Example 9 is the computing system of any of Examples 1-8, where the color distribution features for each image include a set of dominant color representations and associated weights indicating the relative prevalence of each color.

Example 10 is the computing system of Example 9, where the dominant color representations and associated weights are derived using a clustering algorithm applied to the pixel-level color vectors of the image.

Example 11 is the computing system of any of Examples 1-10, where the extracted color distribution features for each image include (a) a vector of cluster centroids representing dominant colors, and (b) a corresponding vector of pixel counts indicating the number of pixels assigned to each centroid.

Example 12 is the computing system of Example 11, where the vectors of cluster centroids and pixel counts are used in computing a similarity matrix between images.

Example 13 is the computing system of any of Examples 1-12, where the prompt does not include any explicit color term, color list, or reference palette, and the alignment score reflects consistency in the text-to-image model's implicit interpretation of the prompt.

Example 14 is the computing system of any of Examples 1-13, where the alignment score is computed without reference to a predefined target color, palette, or ground truth image, and is based solely on internal comparison across the generated images.

Example 15 is the computing system of any of Examples 1-14, where calculating the alignment score includes dividing each image into a plurality of spatial regions and computing the color distribution features separately for each region.

Example 16 is the computing system of Example 15, where similarity measures are computed between corresponding spatial regions of different images, and the alignment score is based on aggregated similarity across regions.

Example 17 is the computing system of Example 15, where the spatial regions are defined using a regular grid of fixed size applied uniformly across the plurality of images.

Example 18 is the computing system of any of Examples 1-17, where using the alignment score includes refining the image generation model using one or more sets of generated images labeled as consistent or inconsistent based on the alignment score.

Example 19 is a method implemented in a computing system that includes at least one hardware processor and at least one memory coupled to the at least one hardware processor. The method includes generating, by a text-to-image model operating under a fixed configuration, a plurality of images in response to a common prompt. A set of color distribution features is extracted for each image based on pixel-level color content. One or more similarity measures are computed based on the extracted features. An alignment score is calculated that reflects the consistency of color composition across the images. The alignment score is used to influence configuration selection, prompt refinement, or image generation workflow behavior to provide an improved alignment score.

Example 20 includes one or more non-transitory computer-readable storage media. The storage media include computer-executable instructions that, when executed by a computing system with at least one hardware processor and at least one memory, cause the computing system to perform a series of operations. A plurality of images is generated by a text-to-image model operating under a fixed configuration in response to a common prompt. Color distribution features are extracted for each image based on pixel-level color content. One or more similarity measures are computed across the set. An alignment score is calculated that reflects the consistency of color composition across the images. The alignment score is used to influence configuration selection, prompt refinement, or image generation workflow behavior to provide an improved alignment score.

### Example 8—Computing Systems

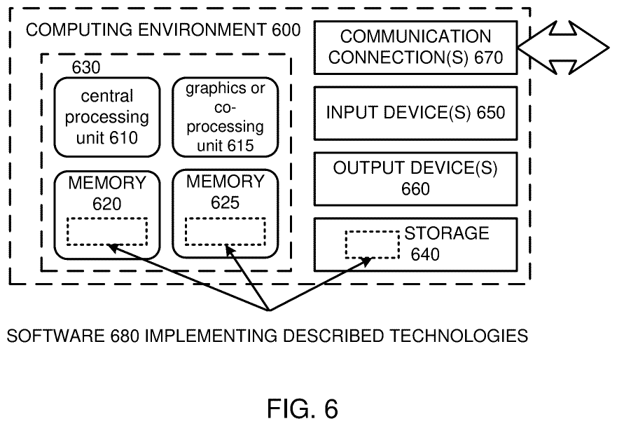

FIG. 6 depicts a generalized example of a suitable computing system 600 in which the described innovations may be implemented. The computing system 600 is not intended to suggest any limitation as to scope of use or functionality of the present disclosure, as the innovations may be implemented in diverse general-purpose or special-purpose computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions, such as for implementing a database environment, and associated methods, described in Examples 1-7. A processing unit can be a general-purpose central processing unit (CPU), a processor in an application-specific integrated circuit (A SIC), or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s) 610, 615. The memory 620, 625 stores software 680 implementing one or more innovations described herein, in the form of computer-executable instructions suitable for execution by the processing unit(s) 610, 615.

A computing system 600 may have additional features. For example, the computing system 600 includes storage 640, one or more input devices 650, one or more output devices 660, and one or more communication connections 670. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 may be removable or non-removable, and includes magnetic disks, magnetic tapes or cassettes, CD-ROM s, DVDs, or any other medium which can be used to store information in a non-transitory way, and which can be accessed within the computing system 600. The storage 640 stores instructions for the software 680 implementing one or more innovations described herein.

The input device(s) 650 may be a touch input device such as a keyboard, mouse, pen, or trackball, a voice input device, a scanning device, or another device that provides input to the computing system 600. The output device(s) 660 may be a display, printer, speaker, CD-writer, or another device that provides output from the computing system 600.

The communication connection(s) 670 enable communication over a communication medium to another computing entity, such as another database server. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 9—Cloud Computing Environment

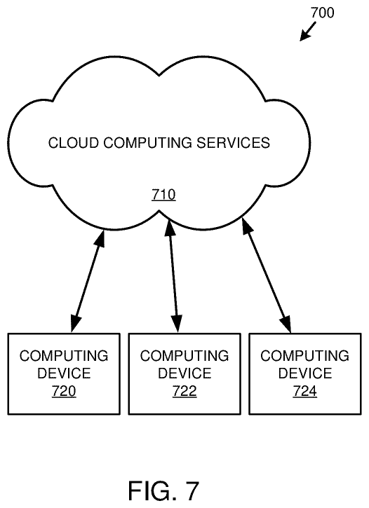

FIG. 7 depicts an example cloud computing environment 700 in which the described technologies can be implemented. The cloud computing environment 700 comprises cloud computing services 710. The cloud computing services 710 can comprise various types of cloud computing resources, such as computer servers, data storage repositories, networking resources, etc. The cloud computing services 710 can be centrally located (e.g., provided by a data center of a business or organization) or distributed (e.g., provided by various computing resources located at different locations, such as different data centers and/or located in different cities or countries).

The cloud computing services 710 are utilized by various types of computing devices (e.g., client computing devices), such as computing devices 720, 722, and 724. For example, the computing devices (e.g., 720, 722, and 724) can be computers (e.g., desktop or laptop computers), mobile devices (e.g., tablet computers or smart phones), or other types of computing devices. For example, the computing devices (e.g., 720, 722, and 724) can utilize the cloud computing services 710 to perform computing operators (e.g., data processing, data storage, and the like).

### Example 10—Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 6, computer-readable storage media include memory 620 and 625, and storage 640. The term computer-readable storage media does not include signals and carrier waves. In addition, the term computer-readable storage media does not include communication connections (e.g., 670).

Any of the computer-executable instructions for implementing the disclosed techniques, as well as any data created and used during implementation of the disclosed embodiments, can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Ruby, ABAP, Structured Query Language, Adobe Flash, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one memory;
one or more hardware processor units coupled to the at least one memory; and
one or more computer readable storage media storing computer-executable instructions that, when executed, cause the computing system to perform operations comprising:
generating, by a text-to-image model operating under a fixed configuration, a plurality of images in response to a common prompt;
extracting, for respective images of the plurality of images, a set of color distribution features based on pixel-level color content of the respective image;
computing one or more similarity measures based on the extracted color distribution features across the plurality of images;
calculating an alignment score that reflects the consistency of color composition across the plurality of images based on the computed similarity measures; and
using the alignment score to influence configuration selection, prompt refinement, or image generation workflow behavior to provide an improved alignment score.

2. The computing system of claim 1, wherein the color distribution features are extracted by converting pixel values of each image into color vectors in a selected color space.

3. The computing system of claim 1, wherein using the alignment score to influence configuration selection comprises modifying one or more of a prompt template, preprocessing logic, image generation model, or post-processing configuration.

4. The computing system of claim 3, wherein modifying the image generation model comprises switching to a different text-to-image model architecture or adjusting one or more generation-time parameters.

5. The computing system of claim 1, wherein configuration refinement is performed iteratively until the alignment score satisfies a predefined consistency threshold or a termination condition is met.

6. The computing system of claim 1, wherein using the alignment score comprises producing an optimized image generation configuration that is used in a downstream inference phase.

7. The computing system of claim 6, further comprising receiving a request to generate an image associated with a new prompt input, processing the prompt input according to the optimized image generation configuration, and returning the generated image in response to the request.

8. The computing system of claim 7, wherein the optimized image generation configuration comprises a prompt template, a selected model, preprocessing and post-processing parameters, and one or more generation-time model settings.

9. The computing system of claim 1, wherein the color distribution features for each image comprise a set of dominant color representations and associated weights indicating the relative prevalence of each color.

10. The computing system of claim 9, wherein the dominant color representations and associated weights are derived using a clustering algorithm applied to the pixel-level color vectors of the image.

11. The computing system of claim 1, wherein the extracted color distribution features for each image comprise:
(a) a vector of cluster centroids representing dominant colors, and
(b) a corresponding vector of pixel counts indicating the number of pixels assigned to each centroid.

12. The computing system of claim 11, wherein the vectors of cluster centroids and pixel counts are used in computing a similarity matrix between images.

13. The computing system of claim 1, wherein the prompt does not include any explicit color term, color list, or reference palette, and the alignment score reflects consistency in the text-to-image model's implicit interpretation of the prompt.

14. The computing system of claim 1, wherein the alignment score is computed without reference to a predefined target color, palette, or ground truth image, and is based solely on internal comparison across the generated images.

15. The computing system of claim 1, wherein calculating the alignment score comprises dividing each image into a plurality of spatial regions and computing the color distribution features separately for each region.

16. The computing system of claim 15, wherein similarity measures are computed between corresponding spatial regions of different images, and the alignment score is based on aggregated similarity across regions.

17. The computing system of claim 15, wherein the spatial regions are defined using a regular grid of fixed size applied uniformly across the plurality of images.

18. The computing system of claim 1, wherein using the alignment score comprises refining the image generation model using one or more sets of generated images labeled as consistent or inconsistent based on the alignment score.

19. A method, implemented in a computing system comprising at least one hardware processor and at least one memory coupled to the at least one hardware processor, the method comprising:
generating, by a text-to-image model operating under a fixed configuration, a plurality of images in response to a common prompt;
extracting, for respective images of the plurality of images, a set of color distribution features based on pixel-level color content of the respective image;
computing one or more similarity measures based on the extracted color distribution features across the plurality of images;
calculating an alignment score that reflects the consistency of color composition across the plurality of images based on the computed similarity measures; and
using the alignment score to influence configuration selection, prompt refinement, or image generation workflow behavior to provide an improved alignment score.

20. One or more non-transitory computer-readable storage media comprising:
computer-executable instructions that, when executed by a computing system comprising at least one hardware processor and at least one memory coupled to the at least one hardware processor, cause the computing system to generate, by a text-to-image model operating under a fixed configuration, a plurality of images in response to a common prompt;
computer-executable instructions that, when executed by the computing system, cause the computing system to extract, for respective images of the plurality of images, a set of color distribution features based on pixel-level color content of the respective image;
computer-executable instructions that, when executed by the computing system, cause the computing system to compute one or more similarity measures based on the extracted color distribution features across the plurality of images;
computer-executable instructions that, when executed by the computing system, cause the computing system to calculate an alignment score that reflects the consistency of color composition across the plurality of images based on the computed similarity measures; and
computer-executable instructions that, when executed by the computing system, cause the computing system to use the alignment score to influence configuration selection, prompt refinement, or image generation workflow behavior to provide an improved alignment score.
